(19) United States
(12) Patent Application Publication
(10) Pub. No.: US 2008/0203892 A1
(43) Pub. Date: Aug. 28, 2008

(54) Illumination System Comprising a Radiation Source and a Luminescent Material

(75) Inventors: Peter Schmidt, Aachen (DE); Walter Mayr, Alsdorf (DE); Jorg Meyer, Aachen (DE); Baby-Seriyati Schreinemacher, Eynatten (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,873

(22) PCT Filed: Mar. 2, 2006
(86) PCT No.: PCT/IB06/50645

§ 371 Date: Sep. 6, 2007

(30) Foreign Application Priority Data
Mar. 8, 2005 (EP) 05101788.7

(51) Int. Cl. H01J 1/62; C09K 11/80

(52) U.S. Cl. 313/486; 252/301.4 R

(57) ABSTRACT

An illumination system comprising a radiation source and a luminescent material comprising at least one phosphor capable of absorbing a part of the light emitted by the radiation source and emitting light of a wavelength different from that of the absorbed light, wherein said at least one phosphor is an amber to red-emitting cerium(III)-activated oxonitrido aluminate silicate of the general formula RE₃₋ₓAl₂Al_{3-y}—Si_{y}O_{12-y}N_{y}:Ceₓ, wherein RE is a rare earth metal, selected from the group of yttrium, gadolinium, lutetium, terbium, scandium and lanthanum, and 0.002≦x≦0.2 and 0<y≦3, can provide light sources having high luminosity and a high color-rendering index, especially in conjunction with a light emitting diode as a radiation source. The amber to red-emitting cerium(III)-activated oxonitrido aluminate silicate of the general formula RE₃₋ₓAl₂Al_{3-y}Si_{y}O_{12-y}N_{y}:Ceₓ, wherein RE is a rare earth metal, selected from the group of yttrium, gadolinium, lutetium, terbium, scandium and lanthanum, and 0.002≦x≦0.2 and 0≦y≦3 is efficiently excitable by primary radiation in the near UV-to-blue range of the electromagnetic spectrum.

### BACKGROUND OF THE INVENTION

The present invention generally relates to an illumination system comprising a radiation source and a luminescent material comprising a phosphor. The invention also relates to a phosphor for use in such an illumination system.

More particularly, the invention relates to an illumination system and luminescent material comprising a phosphor for the generation of specific, colored light, including white light, by luminescent down conversion and additive color mixing based on an ultraviolet or blue radiation-emitting radiation source. A light emitting diode as a radiation source is especially contemplated.

Recently, various attempts have been made to make white light-emitting illumination systems by using light emitting diodes as radiation sources.

A first category of white light-emitting illumination systems using light emitting diodes is based on the use of multiple visible light emitting diodes. In these systems at least two LEDs (e.g. blue and yellow) or three LEDs (e.g. red, blue, and green) are used in combination. The light from the multiple visible light emitting diodes mixes to create a whitish light. But when generating white light with an arrangement of red, green and blue light emitting diodes, the problem that manifests itself is that white light of the desired tone cannot be generated due to variations in tone, luminance and other factors of the light emitting diodes in the course of their lifetime. Complex drive electronics are necessary to compensate for the differential aging and color shifting of each LED.

In order to solve these problems, there have been previously developed illumination systems of a second category, which convert the color of light emitting diodes by means of a luminescent material comprising a phosphor to provide visible white light illumination.

Such phosphor-converted white light illumination systems have been based in particular either on the trichromatic (RGB) approach, i.e. on mixing three colors, namely red, green and blue, in which case the components of the blue output light may be provided by a phosphor and/or by the primary emission of the LED or, in a second, simplified solution, on the dichromatic (BY) approach, i.e. mixing yellow and blue colors, in which case the yellow secondary component of the output light may be provided by a yellow phosphor and the blue component may be provided by a phosphor or by the primary emission of a blue LED. This is the most common phosphor-converted system.

In particular, the dichromatic approach as disclosed in, e.g., U.S. Pat. No. 5,998,925 uses a blue light emitting diode of InGaN-based semiconductor material combined with a Y₃Al₅O₁₂:Ce (YAG-Ce) garnet phosphor. The YAG-Ce phosphor is coated on the InGaN LED, and a portion of the blue light emitted from the LED is converted to yellow light by the phosphor. Another portion of the blue light from the LED is transmitted through the phosphor. Thus, this system emits both blue light, emitted from the LED, and yellow light emitted from the phosphor. The mixture of blue and yellow emission bands is perceived as white light by an observer, with a typical CRI in the mid 70ties and a color temperature Tc that ranges from about 6,000 K to about 8,000 K.

A concern with the LED according to U.S. Pat. No. 5,998,925 is that the “white” output light has an undesirable color balance for true color rendition.

For true color rendition, the figure of merit is the color-rendering index (CRI). CRI describes a light source's ability to accurately render the colors of the objects it illuminates. Measuring the color-rendering index is a relative measurement of how the color rendition of an illumination system compares to that of a black body radiator. The CRI equals 100 if the color coordinates of a set of test colors being illuminated by the illumination system are the same as the coordinates of the same test colors being irradiated by a black body radiator.

True color rendition is of importance as colors in general have the role of providing various information of the visual environment to humans. Colors have a particularly great role as regards the visual information received by drivers of cars driving on roads or in tunnels. For example, on roads and in tunnels which are illuminated by lamps of low CRI, it is difficult to distinguish white and yellow lane markings on the road surface.

Also an important aspect in color recognition is that the red of a surface color be recognized as red. Because red, in particular, is coded for important meanings such as indication of danger, prohibition, stop and fire fighting. Therefore, an important point in improving the visual environment from the viewpoint of safety is illumination that enhances red surfaces.

In case the (BY)-based light source of the dichromatic radiation type described previously is used in such a situation, the problem arises that the probability of recognizing red is reduced, due to the lack of intensity in the red region of the visible light spectrum (647-700 nm range). The red deficiency in the output white light causes illuminated red objects to appear less intense in color than they would under a white light having a well-balanced color characteristic.

### BRIEF SUMMARY OF THE INVENTION

Therefore, a need exists for an efficient and inexpensive white light LED system that is capable of producing white light with a high CRI also in the red range without substantial color shifting, lifetime, or differential aging problems.

Desirable characteristics for illumination systems for general purposes are also high brightness at economical cost.

Thus, the present invention provides an illumination system comprising a radiation source and a luminescent material comprising at least one phosphor capable of absorbing a part of the light emitted by the radiation source and emitting light of a wavelength different from that of the absorbed light, wherein said at least one phosphor is a cerium(III)-activated oxonitrido aluminate silicate of the general formula RE₃₋ₓ Al₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3.

An illumination system according to the present invention can provide a composite white output light that is well balanced with respect to color. In particular, the composite white output light has a greater amount of emission in the red color range than the prior art illumination system. This characteristic makes the device ideal for applications in which a true color rendition is required.

Such applications of the invention include inter alia traffic lighting, street lighting, security lighting and lighting of automated factories, and signal lighting for cars and traffic.

Particularly contemplated is the use of a light emitting diode as a radiation source.

According to a first aspect of the invention, a white light illumination system is provided that comprises a blue-light emitting diode having a peak emission wavelength in the range of 420 to 480 nm as a radiation source and a luminescent material comprising at least one phosphor, that is a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3.

Such an illumination system will provide white light during operation. The blue light emitted by the LED excites the phosphor, causing it to emit amber to red light. The blue light emitted by the LED is transmitted through the phosphor and is mixed with the amber to red light emitted by the phosphor. The viewer perceives the mixture of blue and amber to red light as white light.

While such illumination systems are simple in design, they achieve both a high efficacy and a high color rendering index at low manufacturing costs and a high yield.

The desired spectrum is more closely achieved, as the phosphors according to the invention provide the desired excitation and emission characteristics.

The phosphors have a high conversion efficiency, as they are not subject to significant energy (Stokes) losses due to the conversion of high-energy blue photons to lower energy red photons.

An essential factor is that the excitation spectrum of amber to red phosphors of the cerium(III)-activated earth alkaline oxonitrido aluminate silicate type is so broad-banded in the range of 400 to 490 nm, that they are sufficiently excited by all blue to violet light emitting diodes in the market. As the excitation spectrum of the phosphors according to the invention is centered at 460 to 480 nm, blue LEDs emitting in that wavelength range are preferred.

According to one embodiment of the first aspect, the invention provides a white light illumination system comprising a blue-light emitting diode having a peak emission wavelength in the range of 460 to 480 nm as a radiation source and a luminescent material comprising a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3, and at least one second phosphor.

When the luminescent material comprises a phosphor blend of a phosphor of the cerium(III)-activated oxonitrido aluminate silicate type and at least one second phosphor, the color rendition of the white light illumination system according to the invention may be further improved.

In particular, the luminescent material of this embodiment may be a phosphor blend comprising a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3, and a red phosphor.

Such a red phosphor may be selected from the group of Eu(II)-activated phosphors, selected from the group of (Ca₁₋ₓSrₓ) S:Eu, wherein 0≦x≦1, and (Sr_{1-x-y}BaₓCa_{y})_{2-z}Si₅₋ₐAl₈N₈₋ₐOₐ:Eu_{z}, wherein 0≦a≦5, 0≦x≦1, 0≦y≦1 and 0≦z≦1.

Alternatively, the luminescent material may be a phosphor blend comprising cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3, and a yellow—to green phosphor. Such a yellow—to green phosphor may be selected from the group comprising (Ba₁_{_{—}}ₓSrₓ)₂ SiO₄: Eu, wherein 0≦x≦1, SrGa₂S₄:Eu, SrSi₂N₂O₂:Eu, Ln₃Al₅O₁₂:Ce, wherein Ln comprises lanthanum and all lanthanide metals, and Y₃Al₅O₁₂:Ce.

The emission spectrum of such a luminescent material comprising additional phosphors has the appropriate wavelengths to obtain, together with the blue light of the LED and the amber to red light of the cerium(III)-activated oxonitrido aluminate silicate type of phosphor according to the invention, a high quality white light with good color rendering at the required color temperature.

According to another embodiment of the invention, there is provided a white light illumination system, wherein the radiation source is selected from the light emitting diodes producing an emission with a peak wavelength in the UV-range of 200 to 400 nm, and the luminescent material comprises at least one phosphor, that is a cerium(III)-activated oxonitrido aluminate silicate of the general formula RE₃₋ₓAl₂Al_{3-y}—Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0<y≦3, and a second phosphor.

In particular, the luminescent material according to this embodiment may comprise a white light emitting phosphor blend comprising a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3, and a blue phosphor.

Such a blue phosphor may be selected from the group comprising BaMgAl₁ₒ0₁₇:Eu, Ba₅SiO₄(Cl,Br)₆:Eu, CaLn₂S₄:Ce, wherein Ln comprises lanthanum and all lanthanide metals and (Sr, Ba, Ca)₅(PO₄)₃C1:Eu.

A second aspect of the present invention provides an illumination system emitting red to amber light. Applications of the invention include security lighting as well as signal lighting for cars and traffic.

Especially contemplated is an amber to red light illumination system,

wherein the radiation source is selected from the blue light emitting diodes having an emission with a peak wavelength in the range of 400 to 490 nm, and the luminescent material comprises at least one phosphor, that is a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3.

Also contemplated is an amber to red light illumination system, wherein the radiation source is selected from the light emitting diodes having an emission with a peak wavelength in the UV-range of 200 to 400 nm, and the luminescent material comprises at least one phosphor, that is a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3.

Another aspect of the present invention provides a phosphor capable of absorbing a part of the light emitted by the radiation source and emitting light of a wavelength different from that of the absorbed light; wherein said phosphor is a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0<y≦3.

The luminescent material is excitable by UV-A emission, which has wavelengths in the range of 200 nm to 400 nm, but is excited with higher efficiency by visible blue light emitted by a blue light emitting diode having a wavelength around 400 to 490 nm, especially 450 to 490 nm.

Phosphor materials according to the invention have improved conversion efficiency, resulting in a lower “conversion loss”, since less of the absorbed light is not re-emitted as down-converted light.

In general, the higher the energy of a (e.g., blue or UV) photon that is converted to a lower energy (e.g. yellow) photon, the more light energy is lost (Stokes loss), resulting in an overall decrease in white LED efficiency. Conversion efficiency increases as the gap between the wavelengths of the absorbed and re-emitted light decreases.

Most oxide phosphors cannot be excited by radiation sources emitting at wavelength ranges of more than 400 nm. The luminescent material according to the invention has ideal characteristics for conversion of relatively low energy blue light of a nitride semiconductor light emitting component into white light.

The energy loss, which is associated with the decrease in frequency of the emitted secondary radiation as compared to the absorbed primary radiation, is kept at a minimum. Total conversion efficiency can be up to 90%.

Additional important characteristics of the phosphors include 1) resistance to thermal quenching of luminescence at typical device operating temperatures (e.g. 80° C.); 2) absence of interfering reactivity with the encapsulating resins used in the device fabrication; 3) suitable absorptive profiles to minimize dead absorption within the visible spectrum; 4) a temporally stable luminous output over the operating lifetime of the device and; 5) compositionally controlled tuning of the phosphors' excitation and emission properties.

These cerium(III)-activated oxonitrido aluminate silicate type phosphors may also include europium as a co-activator.

Furthermore, these cerium(III)-activated oxonitrido aluminate silicate type phosphors may also include other cations including mixtures of cations as co-activators selected from the group of europium, praseodymium, samarium, terbium, thulium, dysprosium, holmium and erbium.

Aluminum can also be partly substituted by boron, gallium and scandium in an amount up to 50 mol %

In particular, the invention relates to specific phosphor compositions: Y₃₋ₓAl₄SiO₁₁N:Ceₓ, wherein 0.002≦x≦0.2, which exhibit a high quantum efficiency of 80-90%, a high absorbance in the range of 450 nm to 490 nm of 60-80%, an emission spectrum with a peak wavelength of about 580 to 625 nm and low loss, i.e. below 10% of the luminescent lumen output, due to thermal quenching from room temperature to 100° C.

The invention relates also to the following specific phosphor compositions: Lu₃Al_{4.5}Si_{0.5}O_{11.5}N_{0.5}:Ce(2%) and Y₂GdAl_{4.5}Si_{0.5}O_{11.5}N_{0.5}:Ce(2%), which exhibit a high absorbance in the range of 450 to 500 nm and an emission spectrum with a peak wavelength of about 580 to 625 nm and low loss, i.e. below 10% of the luminescent lumen output, due to thermal quenching from room temperature to 100° C.

These specific phosphor compositions are especially valuable as phosphor in white light emitting phosphor converted LEDs with low color temperature and improved color rendering.

The phosphors according to the invention may have a coating selected from the group of fluorides and orthophosphates of the elements aluminum, scandium, yttrium, lanthanum, gadolinium and lutetium, the oxides of aluminum, yttrium and lanthanum and the nitride of aluminum.

### DETAILED DESCRIPTION OF THE INVENTION

### The Cerium(III)-Activated Oxonitrido Aluminate Silicate Phosphor

The present invention focuses on a cerium(III)-activated oxonitrido aluminate silicate as a phosphor in any configuration of an illumination system containing a radiation source, including, but not limited to, discharge lamps, fluorescent lamps, LEDs, LDs and X-ray tubes. The term “radiation” as used herein encompasses preferably radiation in the UV and visible regions of the electromagnetic spectrum.

While the use of the present phosphor is contemplated for a wide array of illumination purposes, the present invention is described with particular reference to, and finds particular application in combination with, light emitting diodes, especially UV- and blue-light-emitting diodes.

The luminescent material according to the invention comprises a cerium(III)-activated oxonitrido aluminate silicate. The phosphor conforms to the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3. This class of phosphor material is based on activated luminescence of a substituted oxonitrido aluminate silicate.

The phosphor of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3, comprises a host lattice of the garnet type having aluminum, silicon, oxygen and nitrogen as the main components. In the garnet structure A^{[8]}₃B^{[6]}₂C^{[4]}₃O₁₂ the large A atoms are dodecahedrically coordinated by O atoms, the smaller B atoms are octahedrically coordinated by O atoms and the smaller C atoms are tetrahedrically coordinated by O atoms. Because of the similar size of Al and Si atoms and the similar bond lengths of Al—O and Si—N, part of the tetrahedrically coordinated Al atoms can be substituted by Si atoms if the equimolar amount of O atoms is substituted by N atoms to maintain charge neutrality.

Silicon-nitrogen bonds are an advantageous, important component in oxonitrido aluminate silicate compositions intended to obtain a longer wavelength emission and gain at the 580 nm transition of Ce(III).

The inclusion of significant proportions of silicon and nitrogen gives rise to a more covalent bonding. In relatively covalent compositions, the ligand field shifts the emission to longer wavelengths in the red range of the electromagnetic spectrum. This is the nephelauxetic effect, well known in lanthanide ions. The value of the emission cross-section also increases in relatively covalent compositions, reflecting the relationship between the oscillator strength of the transition and the ligand field at the ion site.

Due to the stronger nephelauxetic effect of nitrogen ligands surrounding the Ce(III) activator cations compared to oxygen ligands on the same crystal site, the excitation and emission of RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3 is red shifted compared to prior art Y₃₋ₓAl₅O₂:Ceₓ, (FIG. 3).

Within the basic host lattice, partial or complete substitution of trivalent aluminum metal ions by boron, gallium and scandium in an amount up to 10 mol % is possible.

The proportion x of cerium(III) is preferably in a range of 0.002≦x≦0.2. When the proportion x of cerium(III) is 0.002 or lower, luminance decreases because the number of excited emission centers of photoluminescence due to cerium(III)—cations decreases and, when z is greater than 0.2, concentration quenching occurs. Concentration quenching refers to the decrease in emission intensity, which occurs when the concentration of an activation agent added to increase the luminance of the luminescent material is increased beyond an optimum level.

Replacing some of the cerium in a cerium-activated oxonitrido aluminate silicate by europium as a co-activator has the effect that the europium produces secondary emission that is concentrated in the deep red region of the visible spectrum, instead of a typical broadband secondary emission from cerium(III)—activated oxonitrido aluminate silicate phosphor that is generally centered in the amber region of the visible spectrum.

Co-activators, such as praseodymium, samarium, terbium, thulium, dysprosium, holmium and erbium may also be used.

As regards the method used for producing a microcrystalline phosphor powder of the present invention, there are no particular restrictions, i.e. said microcrystalline phosphor powder can be produced by any method capable of providing phosphors according to the invention. A series of compositions of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0≦y≦3, can be manufactured, which form a complete solid solution for the range of 0.002≦x≦0.2 and 0≦y≦3.

A preferred process for producing a phosphor according to the invention is referred to as the solid-state method. In this process, the phosphor precursor materials are mixed in the solid state and are heated so that the precursors react and form a powder of the phosphor material.

In a specific embodiment, these amber to red emitting phosphors are prepared as phosphor powders by means of the following technique: To prepare the mixed oxides of the trivalent metals, high-purity nitrates, carbonates, oxalates and acetates of yttrium, aluminium and cerium(III) were dissolved by stirring in 25-30 ml deionized water. The solution is buffered and the oxides precipitated by ammonia. The suspension is stirred and heated on a hot-plate for 24 h, and then filtered.

The solids are dried overnight (12 hours) at 120° C. The resulting solid is finely ground and placed into a high-purity alumina crucible. The crucibles are loaded into a charcoal-containing basin and then into a tube furnace and purged with flowing carbon monoxide for several hours. The furnace parameters are 10° C./min to 900° C., followed by a 4 hour dwell at 900° C., after which the furnace is turned off and allowed to cool to room temperature.

These metal oxides are mixed with silicon nitride Si₃N₄ and a flux in predetermined ratios.

The mixture is placed into a high-purity alumina crucible. The crucibles are loaded into a charcoal-containing basin and then into a tube furnace and purged with flowing nitrogen/hydrogen for several hours. The furnace parameters are 10° C./min to 1650° C., followed by a 4 hour dwell at 1650° C., after which the furnace is slowly cooled to room temperature.

The samples are again finely ground before a second annealing step at 1600° C. is performed.

Luminous output may be improved through an additional third anneal at slightly lower temperatures in flowing argon.

Phosphor powder materials can also be made by liquid precipitation. In this method, a solution, which includes soluble phosphor precursors, is chemically treated to precipitate phosphor particles or phosphor particle precursors. These particles are typically calcined at an elevated temperature to produce the phosphor compound.

In yet another method, phosphor powder particle precursors or phosphor particles are dispersed in a slurry, which is then spray-dried to evaporate the liquid. The particles are subsequently sintered in the solid state at an elevated temperature to crystallize the powder and form a phosphor. The spray-dried powder is then converted to an oxonitrido aluminate silicate phosphor by sintering at an elevated temperature to crystallize the powder and to form the phosphor. The fired powder is then lightly crushed, milled and sieved to recover phosphor particles of desired particle size.

After firing, the powders were characterized by powder X-ray diffraction (Cu, Kα-line), which showed that the desired phase had formed.

A yellow to amber powder is obtained, which efficiently luminescences under UV and blue excitation.

When excited with radiation of a wavelength of 470 nm, specific composition Lu₃Al_{4.5}Si_{0.5}O_{11.5}N_{0.5}:Ce(2%) is found to give a broadband emission, with peak wavelength at 586 nm tailing out to 780 nm.

The color point is at x=0.427 and y=0.522. The quantum efficiency is 80%

In FIG. 4 of the drawings accompanying this specification, the excitation, emission and reflection spectra of specific composition Y₂GdAl_{4.5}Si_{0.5}O_{11.5}N_{0.5}:Ce(2%) are given.

From the excitation spectra, it is also clear that cerium(III)-activated oxonitrido aluminate silicate phosphor materials according to the invention can be excited efficiently with radiation of a wavelength between 450 nm and 490 nm.

Preferably, the cerium(III)-activated oxonitrido aluminate silicate type phosphors according to the invention may be coated with a thin, uniform protective layer of one or more compounds selected from the group formed by the fluorides and orthophosphates of the elements aluminum, scandium, yttrium, lanthanum gadolinium and lutetium, the oxides of aluminum, yttrium and lanthanum and the nitride of aluminum.

The protective layer thickness customarily ranges from 0.001 to 0.2 μm and, thus, is so thin that it can be penetrated by the radiation from the radiation source without substantial loss of energy. The coatings of these materials on the phosphor particles can be applied, for example, by deposition from the gas phase or a wet-coating process.

### The Illumination System

The invention also concerns an illumination system comprising a radiation source and a luminescent material comprising at least one cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium and lanthanum, and 0.002≦x≦0.2 and 0<y≦3.

Radiation sources include semiconductor optical radiation emitters and other devices that emit optical radiation in response to electrical excitation. Semiconductor optical radiation emitters include light emitting diode LED chips, light emitting polymers (LEPs), organic light emitting devices (OLEDs), polymer light emitting devices (PLEDs), etc.

Moreover, light emitting components such as those found in discharge lamps and fluorescent lamps, such as mercury low and high pressure discharge lamps, sulfur discharge lamps, and discharge lamps based an molecular radiators are also contemplated for use as radiation sources with the present inventive phosphor compositions.

In a preferred embodiment of the invention, the radiation source is a light-emitting diode (LED).

Any configuration of an illumination system which includes a light emitting diode and a cerium(III)-activated oxonitrido aluminate silicate phosphor composition is contemplated in the present invention, preferably with the addition of other well-known phosphors, which can be combined to achieve a specific color or white light when irradiated by a LED emitting primary UV or blue light as specified above.

A detailed construction of one embodiment of such an illumination system comprising a radiation source and a luminescent material shown in FIG. 1 will now be described.

FIG. 1 shows a schematic view of a chip-type light emitting diode with a coating comprising the luminescent material. The device comprises chip-type light emitting diode (LED) 1 as a radiation source. The light-emitting diode die is positioned in a reflector cup lead frame 2. The die 1 is connected via a bond wire 7 to a first terminal 6, and directly to a second electric terminal 6. The recess of the reflector cup is filled with a coating material that contains a luminescent material according to the invention to form a coating layer that is embedded in the reflector cup. The phosphors are applied either separately or in a mixture.

The coating material typically comprises a polymer for encapsulating the phosphor or phosphor blend. In this embodiment, the phosphor 4 or phosphor blend 4,5 should exhibit high stability properties against the encapsulant. Preferably, the polymer is optically clear to prevent significant light scattering. A variety of polymers are known in the LED industry for making LED illumination systems.

In one embodiment, the polymer is selected from the group consisting of epoxy and silicone resins. Adding the phosphor mixture to a liquid that is a polymer precursor can bring about encapsulation. For example, the phosphor mixture can be a granular powder. Introducing phosphor particles into polymer precursor liquid results in the formation of a slurry (i.e. a suspension of particles). Upon polymerization, the phosphor mixture is fixed rigidly in place by the encapsulation. In one embodiment, both the luminescent material and the LED die are encapsulated in the polymer.

The transparent coating material may comprise light-diffusing particles, advantageously so-called diffusers. Examples of such diffusers are mineral fillers, in particular CaF₂, TiO₂, SiO₂, CaCO₃ or BaSO₄ or any other organic pigments. These materials can be added in a simple manner to the above-mentioned resins.

In operation, electrical power is supplied to the die to activate the die. When activated, the die emits primary light, e.g. blue light. A portion of the emitted primary light is completely or partially absorbed by the luminescent material in the coating layer. The luminescent material then emits secondary light, i.e., the converted light having a longer peak wavelength, primarily amber in a sufficiently broad band (specifically with a significant proportion of red) in response to absorption of the primary light. The remaining unabsorbed portion of the emitted primary light is transmitted through the luminescent layer, along with the secondary light. The encapsulation directs the unabsorbed primary light and the secondary light in a general direction as output light. Thus, the output light is a composite light that is composed of the primary light emitted from the die and the secondary light emitted from the luminescent layer.

The color temperature or color point of the output light of an illumination system according to the invention will vary depending upon the spectral distributions and intensities of the secondary light in comparison to the primary light.

Firstly, the color temperature or color point of the primary light can be varied by a suitable choice of the light emitting diode.

Secondly, the color temperature or color point of the secondary light can be varied by a suitable choice of the phosphor in the luminescent material, its particle size and its concentration. Furthermore, these arrangements also advantageously afford the possibility of using phosphor blends in the luminescent material, as a result of which, advantageously, the desired hue can be set even more accurately.

### The White Light Phosphor Converted Light Emitting Device

According to one aspect of the invention, the output light of the illumination system may have a spectral distribution such that it appears to be “white” light. The most popular white LEDs consist of blue emitting LED chips that are coated with a phosphor that converts some of the blue radiation to a complimentary color, e.g. a yellow to amber emission. Together, the blue and yellow emissions produce white light.

There are also white LEDs which utilize a UV emitting chip and phosphors designed to convert the UV radiation to visible light. Typically, two or more phosphor emission bands are required.

### Blue/Phosphor White LED

(Dichromatic White Light Phosphor Converted Light Emitting Device using Blue Emitting Light Emitting Diode)

In a first embodiment, by choosing the luminescent material such that blue radiation emitted by a blue-light emitting diode is converted into complementary wavelength ranges, to form dichromatic white light, a white-light emitting illumination system according to the invention can advantageously be produced.

In this case, amber to red light is produced by means of the luminescent materials that comprise a cerium(III)-activated oxonitrido aluminate silicate phosphor. Also a second luminescent material can be used, in addition, in order to improve the color rendition of this illumination system.

Particularly good results are achieved with a blue LED whose emission maximum lies at 400 to 490 nm. An optimum has been found to lie at 470 nm, taking particular account of the excitation spectrum of the cerium(III)-activated oxonitrido aluminate silicate.

A white-light emitting illumination system according to the invention can particularly preferably be realized by admixing the inorganic luminescent material Y₃₋ₓAl₄SiO₁₁N:Ceₓ, wherein 0.002≦x≦0.2, with a silicon resin used to produce the luminescence conversion encapsulation or layer.

Part of blue radiation emitted by a 470 nm InGaN light emitting diode is shifted by the inorganic luminescent material Y₃₋ₓAl₄SiO₁₁N:Ceₓ, wherein 0.002≦x≦0.2, into the orange spectral region and, consequently, into a wavelength range which is complementarily colored with respect to the color blue. A human observer perceives the combination of blue primary light and the secondary light of the amber-emitting phosphor as white light.

TABLE 1
Colorimetric data of illumination grade white pcLEDs with
Y_{2.94}SiAl₄O₁₁N:Ce_{0.06} phosphor

| sample | LED A | LED B |
|---|---|---|
| CCT [K] | 4220 | 3939 |
| color point x, y | 0.375, 0.389 | 0.390, 0.403 |
| Ra | 81 | 81 |
| R9 | 14 | 16 |

FIG. 2 shows the emission spectra of such an illumination system comprising a blue emitting InGaN die with primary emission at 470 nm and Y₃₋ₓ—Al₄SiO₁₁N:Ceₓ, wherein x=0.06, as the luminescent material, which together form an overall spectrum which conveys a white color sensation of high quality.

When its spectral distribution is compared with the spectral distribution of the white output light generated by the prior art LED, the apparent difference in the spectral distribution is the shift of the peak wavelength, which is in the red region of the visible spectrum. Thus, the white output light generated by the illumination system has a significant additional amount of red color, as compared to the output light generated by the prior art LED.

(Polychromatic White Light Phosphor Converted Light Emitting Device using Blue Emitting Light Emitting Diode)

In a second embodiment, by choosing the luminescent material such that blue radiation emitted by the blue-light emitting diode is converted into complementary wavelength ranges, to form polychromatic white light, a white-light emitting illumination system according to the invention can advantageously be produced. In this case, amber to red light is produced by means of the luminescent materials that comprise a blend of phosphors including cerium(III)-activated oxonitrido aluminate silicate phosphor and a second phosphor.

White light emission with even higher color rendering is possible by using additional red and green broadband emitter phosphors covering the whole spectral range together with a blue emitting LED and an amber to red emitting cerium(III)-activated oxonitrido aluminate silicate phosphor.

Useful second phosphors and their optical properties are summarized in the following table 2.

TABLE 2

| Composition | λₘₐₓ [nm] | Color point x, y |
|---|---|---|
| (Ba₁₋ₓSrₓ)₂SiO₄:Eu | 523 | 0.272, 0.640 |
| SrGa₂S₄:Eu | 535 | 0.270, 0.686 |
| SrSi₂N₂O₂:Eu | 541 | 0.356, 0.606 |
| SrS:Eu | 610 | 0.627, 0.372 |
| (Sr_{1-x-y}CaₓBa_{y})₂Si₅N₈:Eu | 615 | 0.615, 0.384 |
| (Sr_{1-x-y}CaₓBa_{y})₂Si₅₋ₐAlₐN₈₋ₐOₐ:Eu | 615-650 | * |
| CaS:Eu | 655 | 0.700, 0.303 |
| (Sr₁₋ₓCaₓ)S:Eu | 610-655 | * |

The luminescent materials may be a blend of two phosphors, an amber to red cerium(III)-activated oxonitrido aluminate silicate phosphor and a red phosphor selected from the group (Ca₁₋ₓSrₓ) S:Eu, wherein 0≦x≦1, and (Sr_{1-x-y}BaₓCaₓ)₂Si₅₋ₐAlₐN₈₋ₐOₐ:Eu, wherein 0≦a<5, 0≦x≦1 and 0≦y≦1.

The luminescent materials may be a blend of two phosphors, e.g. an amber to red cerium(III)-activated oxonitrido aluminate silicate phosphor and a green phosphor selected from the group comprising (Ba₁_{_{—}}ₓSrₓ)₂ SiO₄: Eu, wherein 0≦x≦1, SrGa₂S₄:Eu and SrSi₂N₂O₂:Eu.

The luminescent materials may be a blend of three phosphors, e.g. an amber to red cerium(III)-activated oxonitrido aluminate silicate phosphor, a red phosphor selected from the group (Ca₁₋ₓSrₓ) S:Eu, wherein 0≦x≦1, and (Sr_{1-x-y}BaₓCa_{y})₂Si₅₋ₐAlₐN₈₋ₐOₐ: Eu, wherein 0≦a<5, 0≦x≦1, and 0≦y≦1, and a yellow to green phosphor selected from the group comprising (Ba₁_{_{—}}ₓSrₓ)₂ SiO₄: Eu, wherein 0≦x≦1, SrGa₂S₄:Eu and SrSi₂N₂O₂:Eu.

A white-light emitting illumination system according to the invention can particularly preferably be realized by admixing the inorganic luminescent material comprising a mixture of three phosphors with a silicon resin used to produce the luminescence conversion encapsulation or layer. A first phosphor (1) is the amber emitting oxonitrido aluminate silicate Y_{2.94}SiAl₄O₁₁N:Ce_{0.06}, the second phosphor (2) is the red emitting CaS:Eu, and the third (3) is a green emitting phosphor of type SrSi₂N₂O₂:Eu.

Part of blue radiation emitted by a 470 nm InGaN light emitting diode is shifted by the inorganic luminescent material Y_{2.94}SiAl₄O₁₁N:Ce_{0.06} into the amber spectral region and, consequently, into a wavelength range which is complementarily colored with respect to the color blue. Another part of blue radiation emitted by a 470 nm InGaN light emitting diode is shifted by the inorganic luminescent material CaS:Eu into the red spectral region. Still another part of blue radiation emitted by a 470 nm InGaN light emitting diode is shifted by the inorganic luminescent material SrSi₂N₂O₂:Eu into the green spectral region. A human observer perceives the combination of blue primary light and the polychromatic secondary light of the phosphor blend as white light.

The hue (color point in the CIE chromaticity diagram) of the white light thus produced can in this case be varied by a suitable choice of the phosphors in respect of mixture and concentration.

### UV/Phosphor White LED

(Dichromatic White Phosphor Converted Light Emitting Device using UV-Radiation)

In a third embodiment, a white-light emitting illumination system according to the invention can advantageously be produced by choosing the luminescent material such that a UV radiation emitted by the UV light emitting diode is converted into complementary wavelength ranges, to form dichromatic white light. In this case, the amber and blue light is produced by means of the luminescent materials. Amber light is produced by means of the luminescent materials that comprise a cerium(III)-activated oxonitrido aluminate silicate phosphor. Blue light is produced by means of the luminescent materials that comprise a blue phosphor selected from the group comprising BaMgAl₁ₒ0₁₇:Eu, Ba₅SiO₄(Cl,Br)₆: Eu, CaLn₂S₄:Ce and (Sr,Ba, Ca)₅(PO₄)₃Cl:Eu.

Particularly good results are achieved in conjunction with a UVA light emitting diode, whose emission maximum lies at 200 to 400 nm. An optimum has been found to lie at 365 nm, taking particular account of the excitation spectrum of the cerium(III)-activated oxonitrido aluminate silicate.

Polychromatic White Phosphor Converted Light Emitting Device using UV Emitting-LED

In a fourth embodiment, a white-light emitting illumination system according to the invention can advantageously be produced by choosing the luminescent material such that UV radiation emitted by a UV emitting diode is converted into complementary wavelength ranges, to form polychromatic white light e.g. by additive color triads, for example blue, green and red.

In this case, the red, green and blue light is produced by means of the luminescent materials.

Also a second red luminescent material can be used, in addition, in order to improve the color rendition of this illumination system.

White light emission with even higher color rendering is possible by using blue and green broadband emitter phosphors covering the whole spectral range together with a UV emitting LED and a red emitting cerium(III)-activated oxonitrido aluminate silicate phosphor.

The luminescent materials may be a blend of three phosphors, a red cerium(III)-activated oxonitrido aluminate silicate phosphor, a blue phosphor selected from the group comprising BaMgAl₁ₒ0₁₇:Eu, Ba₅SiO₄(Cl,Br)₆:Eu, CaLn₂S₄:Ce and (Sr,Ba, Ca)₅(PO₄)₃C1:Eu and a yellow to green phosphor selected from the group comprising (Ba₁_{_{—}}ₓSrₓ)₂ SiO₄: Eu, wherein 0≦x≦1, SrGa₂S₄:Eu and SrSi₂N₂O₂:Eu.

The hue (color point in the CIE chromaticity diagram) of the white light thus produced can in this case be varied by a suitable choice of the phosphors in respect of mixture and concentration.

### The Amber to Red Phosphor Converted Light Emitting Device

According to a further aspect of the invention, an illumination system that emits output light having a spectral distribution such that it appears to be “amber to red” light is contemplated.

A luminescent material comprising cerium(III)-activated oxonitrido aluminate silicate as a phosphor is particularly well suited as an amber to red component for stimulation by a primary UVA or blue radiation source such as, for example, an UVA emitting LED or a blue emitting LED.

It is possible in this connection to implement an illumination system emitting in the amber to red regions of the electromagnetic spectrum.

In a fifth embodiment, an amber-light emitting illumination system according to the invention can advantageously be produced by choosing the luminescent material such that blue radiation emitted by the blue-light emitting diode is converted into complementary wavelength ranges, to form dichromatic amber to red light.

In this case, amber to red light is produced by means of the luminescent materials that comprise a cerium(III)-activated oxonitrido aluminate silicate phosphor.

The color output of the LED-phosphor system is very sensitive to the thickness of the phosphor layer, i.e. if the phosphor layer is thick and comprises an excess of an amber cerium(III)-activated oxonitrido aluminate silicate phosphor, then a lesser amount of the blue LED light will penetrate through the thick phosphor layer. The combined LED—phosphor system will then appear amber to red, because the amber to red secondary light of the phosphor dominates it. Therefore, the thickness of the phosphor layer is a critical variable affecting the color output of the system.

The hue (color point in the CIE chromaticity diagram) of the amber to red light thus produced can in this case be varied by a suitable choice of the phosphor in respect of mixture and concentration.

In a sixth embodiment, an amber to red-light emitting illumination system according to the invention can advantageously be produced by choosing the luminescent material such that UV radiation emitted by the UV emitting diode is converted entirely into monochromatic amber to red light. In this case, the amber to red light is produced by means of the luminescent materials.

### BRIEF DESCRIPTION OF THE DRAWINGS

FIG. 1 shows a schematic view of a dichromatic white LED lamp comprising a phosphor of the present invention positioned in a pathway of light emitted by an LED structure.

FIG. 2 shows the spectral radiance of an illumination system comprising a blue LED and Y₃₋ₓAl₄SiO₁₁N:Ceₓ, wherein x=0.06, as luminescent material.

FIG. 3 shows the emission spectrum of Lu₃Al_{4.5}Si_{0.5}O_{11.5}N_{0.5}:Ce(2%) in comparison to YAG:Ce.

FIG. 4 shows excitation, reflection and emission of Y₂GdAl_{4.5}Si_{0.5}O_{11.5}N_{0.5}:Ce(2%) in comparison to the emission of YAG:Ce

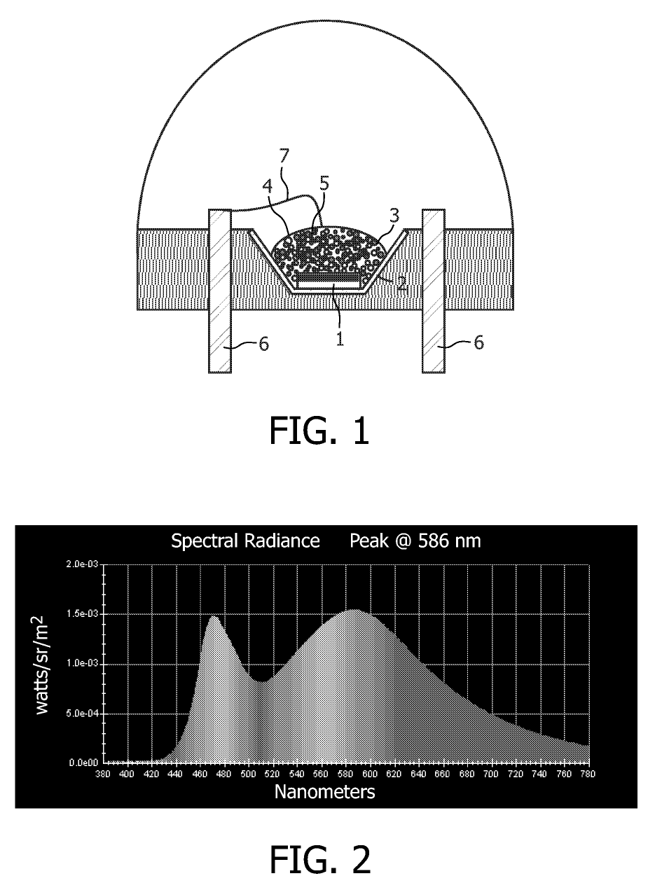

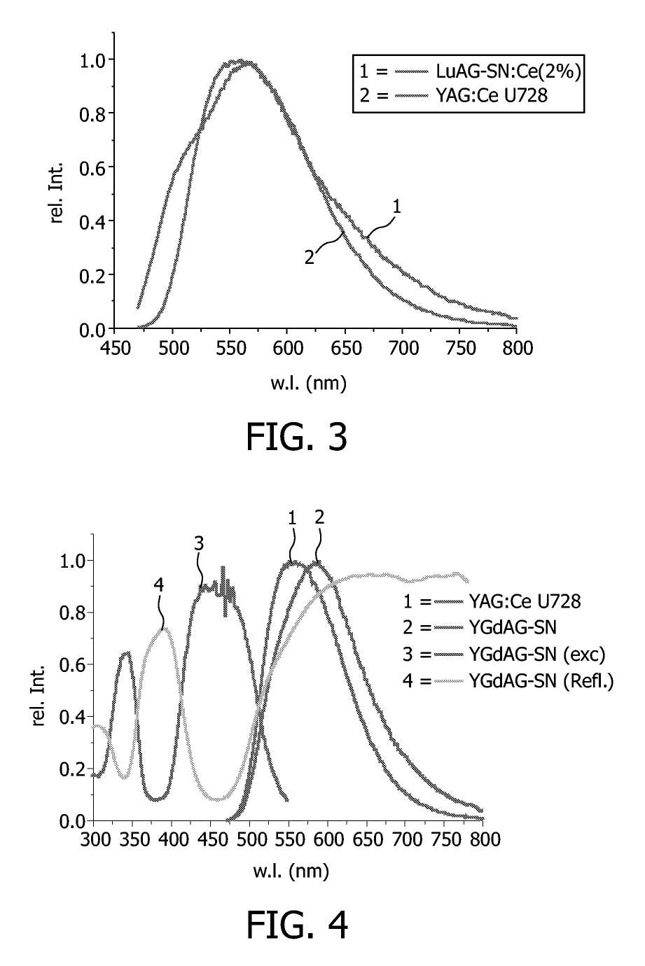

1-19. (canceled)

20. Illumination system comprising a radiation source and a luminescent material comprising at least one phosphor capable of absorbing a part of light emitted by the radiation source and emitting light of a wavelength different from that of the absorbed light, wherein said at least one phosphor is a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium, lanthanum and combinations thereof, and 0.002≦x≦0.2 and 0≦y≦3.

21. Illumination system according to claim 20, wherein the radiation source is a light emitting diode.

22. Illumination system according to claim 20, wherein the radiation source is selected from the blue light emitting diodes having an emission with a peak wavelength in the range of 400 to 490 nm, and wherein the luminescent material comprises a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium, lanthanum and combinations thereof, and 0.002≦x≦0.2 and 0≦y≦3.

23. Illumination system according to claim 20, wherein the radiation source is selected from the light emitting diodes having an emission with a peak wavelength in the range of 400 to 490 nm, and the luminescent material comprises a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium, lanthanum and combinations thereof, and 0.002≦x≦0.2 and 0≦y≦3, and a second phosphor.

24. Illumination system according to claim 23, wherein the second phosphor is a red phosphor selected from the group (Ca₁₋ₓSrₓ) S:Eu, wherein 0≦x≦1, and (Sr_{1-x-y}BaₓCa_{y})_{2-z}Si₅₋ₐAlN^{8-a}OₐEu_{z}, wherein 0≦a<5.0≦x≦1,0≦y≦1 and 0≦z≦0.09.

25. Illumination system according to claim 23, wherein the second phosphor is a yellow to green phosphor selected from the group comprising (Ba₁₋ₓSrₓ)₂ SiO₄:Eu, wherein 0≦x≦1, SrGa₂S₄:Eu, SrSi₂N₂O₂:Eu, Ln₃Al₅O₁₂:Ce, wherein Ln comprises lanthanum and all lanthanide metals, and Y₃Al₅O₁₂:Ce

26. Illumination system according to claim 20, wherein the radiation source is selected from the light emitting diodes having an emission with a peak wavelength in the UV range of 200 to 400 nm, and wherein the luminescent material comprises a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium, lanthanum and combinations thereof, and 0.002≦x≦0.2 and 0≦y≦3.

27. Illumination system according to claim 20, wherein the radiation source is selected from the light emitting diodes having an emission with a peak wavelength in the UV-range of 200 to 400 nm, and wherein the luminescent material comprises a cerium(III)-activated oxonitrido aluminate silicate of the general formula RE₃₋ₓAl₂Al_{3-y}Si_{y}O_{12-y}N_{y}:Ceₓ, wherein RE is a rare earth metal selected from the group of yttrium, gadolinium, lutetium, terbium, scandium, lanthanum and combinations thereof, and 0.002≦x≦0.2 and 0≦y≦3, and a second phosphor.

28. Illumination system according to claim 27, wherein the second phosphor is a blue phosphor selected from the group of BaMgAl₁ₒ0₁₇:Eu, Ba₅SiO₄(Cl,Br)₆:Eu, CaLn₂S₄:Ce, (Sr,Ba, Ca)₅(PO₄)₃C1:Eu and LaSi₃N₅:Ce.

29. Illumination system according to claim 27, wherein the second phosphor is a red phosphor selected from the group of (Ca₁₋ₓSrₓ) S:Eu, wherein 0≦x≦1, and (Sr_{1-x-y}BaₓCa_{y})_{2-z}Si₅₋ₐAlₐN₈₋ₐOₐ:Eu_{z}, wherein 0≦a≦5.00≦x≦1,0≦y≦1 and 0≦z≦0.09.

30. Illumination system according to claim 27, wherein the second phosphor is a yellow to green phosphor selected from the group comprising (Ba₁₋ₓSrₓ)₂ SiO₄:Eu, wherein 0≦x≦1, SrGa₂S₄:Eu, SrSi₂N₂O₂:Eu, Ln₃Al₅O₁₂:Ce, wherein Ln comprises lanthanum and all lanthanide metals, and Y₃Al₅O₁₂:Ce

31. Phosphor capable of absorbing a part of light emitted by the radiation source and emitting light of a wavelength different from that of the absorbed light, wherein said phosphor is a cerium(III)-activated oxonitrido aluminate silicate of the general formula RE₃₋ₓAlAl_{3-y}Si_{y}O_{12-y}N_{y}:Ceₓ, wherein RE is a rare earth metal selected from the group of yttrium, gadolinium, lutetium, terbium, scandium, lanthanum and combinations thereof, and 0.002≦x≦0.2 and 0≦y≦3.

32. Phosphor according to claim 31, wherein, in said phosphor, aluminum is partially substituted by boron, gallium and scandium in an amount up to 50 mol %.

33. Phosphor according to claim 31, wherein said phosphor additionally comprises europium as a co-activator.

34. Phosphor according to claim 31, wherein said phosphor additionally comprises a co-activator selected from the group of praseodymium, samarium, terbium, thulium, dysprosium, holmium and erbium.

35. Phosphor according to claim 31, wherein said phosphor is a cerium(III)-activated oxonitrido aluminate silicate of the general formula Y₃₋ₓAl₄SiO₁₁N:Ceₓ, wherein 0.002≦x≦0.2.

36. Phosphor according to claim 31, wherein said phosphor is a cerium(III)-activated oxonitrido aluminate silicate of the general formula Lu₃Al_{4.5}Si_{0.5}O_{11.5}N_{0.5}:Ce(2%).

37. Phosphor according to claim 31, wherein said phosphor is a cerium(III)-activated oxonitrido aluminate silicate of the general formula Y₂GdAl_{4.5}Si_{0.5}O_{11.5}N_{0.5}:Ce(2%).

38. Phosphor according to claim 31, wherein the phosphor has a coating selected from the group of fluorides and orthophosphates of the elements aluminum, scandium, yttrium, lanthanum gadolinium and lutetium, the oxides of aluminum, yttrium and lanthanum and the nitride of aluminum.
